(19) United States
(12) Patent Application Publication
(10) Pub. No.: US 2024/0393782 A1
(43) Pub. Date: Nov. 28, 2024

(54) METHOD FOR ESTIMATING THE NEED TO REPLACE A CUTTING TOOL

(71) Applicants: Airbus SAS, BLAGNAC (FR); Airbus Operations SAS, TOULOUSE (FR)

(72) Inventors: Caroline LE GALL, BLAGNAC (FR); Wilfried GRAVOUIL, ROCHEFORT (FR); David THIBAUD, ROCHEFORT (FR)

(21) Appl. No.: 18/669,625

(22) Filed: May 21, 2024

(30) Foreign Application Priority Data
May 22, 2023 (FR) 2305027

(51) Int. Cl. G05B 23/02; B23Q 17/09

(52) U.S. Cl. CPC G05B 23/0283; B23Q 17/0995

(57) ABSTRACT

A method for estimating the need to replace a cutting tool includes the following steps: collecting data representative of efforts undergone by the cutting tool during cutting tool usage operations, each datum associating a cutting tool usage operation number and at least one measurement of effort during the cutting tool usage operation; comparing the collected data, or data which are derived therefrom, with a reference curve representative of a nominal wear of the cutting tool during the cutting tool usage operations; checking whether or not the collected data, or the data which are derived therefrom, cause an overshoot of a predefined tolerance with respect to the reference curve; and in the event of such an overshoot, deducing an appropriate moment to perform a replacement of the cutting tool, as a function of the overshoot. The cutting tool may then be replaced at or near the deduced appropriate moment.

### CROSS-REFERENCES TO RELATED APPLICATIONS

This application claims the benefit of French Patent Application Number 2305027 filed on May 22, 2023, the entire disclosures of which are incorporated herein by way of reference.

### FIELD OF THE INVENTION

The present invention relates to the monitoring of a cutting tool in order to determine an appropriate moment for performing a cutting tool replacement.

### BACKGROUND OF THE INVENTION

The generation of heat, pressure, friction and the distribution of stresses are important cutting tool wear factors.

Many operations are performed with cutting tools (drill bits, et cetera) in the construction of an aircraft. Managing the replacement of these cutting tools is then an issue of major importance in this context.

The theoretical lifetime of a cutting tool is typically defined during qualification phases which take account of a nominal use of the cutting tool. The theoretical lifetime of the cutting tool is thus purely indicative, and the actual lifetime can be shorter or longer than the theoretical lifetime depending on the operations actually performed with this cutting tool (for example, according to the real depth of drilling of holes performed with an electric drill).

It is then difficult to estimate the appropriate moment at which to perform a replacement of the cutting tool, so as notably to avoid damaging a part on which the cutting tool concerned is used or else so as to prolong time of use of the cutting tool when its actual wear so allows. It is therefore desirable to provide a solution which makes it possible to mitigate this drawback of the state of the art.

### SUMMARY OF THE INVENTION

A method is thus proposed here for estimating the need to replace a cutting tool, the method being implemented by a system in the form of electronic circuitry, the method comprising the following steps: collecting data representative of efforts undergone by the cutting tool in the course of cutting tool usage operations, each datum associating a cutting tool usage operation number and at least one measurement of effort during the cutting tool usage operation; comparing the collected data, or data which are derived therefrom, with a reference curve or reference discrete values representative of a nominal wear of the cutting tool in the course of the cutting tool usage operations; checking whether or not the collected data, or the data which are derived therefrom, cause a predefined tolerance to be overshot with respect to the reference curve or respectively to the reference discrete values; and in the event of the overshoot, deducing an appropriate moment to perform a replacement of the cutting tool, as a function of the overshoot.

Thus, it is possible to estimate the appropriate moment at which to perform a replacement of the cutting tool, so as notably to avoid damaging a part on which the cutting tool concerned is used or else so as to prolong the time of use of the cutting tool when its actual wear so permits.

In a particular embodiment, the at least one effort measurement during the cutting tool usage operation includes a torque measurement.

In a particular embodiment, the at least one effort measurement during the cutting tool usage operation includes a function of torque measurements in the course of the cutting tool usage operation.

In a particular embodiment, the method comprises the following steps: performing a principal components analysis of the function in the course of the cutting tool usage operations; obtaining the distribution of values of the second principal component, and applying a statistical detection of atypical behaviors by considering a standard deviation tolerance with respect to the mean of the distribution.

In a particular embodiment, the method comprises the following steps: performing a principal components analysis of the function in the course of the cutting tool usage operations; comparing the second principal component to the reference curve or respectively to the reference discrete values.

In a particular embodiment, the method comprises the following step: monitoring the overshooting, or not, of the predefined tolerance with respect to the reference curve or respectively to the reference discrete values in real-time, namely in the course of the cutting tool usage operations, and generating an alert to stop use of the cutting tool when the overshoot is observed after a cutting tool usage operation.

In a particular embodiment, the method comprises the following steps: injecting the collected data into a convolution neural network of ROCKET type connected at the output to a ridge regression model; and comparing the output of the ridge regression model to the reference curve or respectively to the reference discrete values.

In a particular embodiment, the method comprises the following step: monitoring the overshooting, or not, of the predefined tolerance with respect to the reference curve or respectively to the reference discrete values in predictive mode using the ridge regression model so as to generate an estimation of stoppage of use of the cutting tool.

In a particular embodiment, the cutting tool is a drill bit.

Also proposed is a system in the form of electronic circuitry configured to perform an estimation of need to replace a cutting tool and to implement the following steps: collecting data representative of efforts undergone by the cutting tool in the course of cutting tool usage operations, each datum associating a cutting tool usage operation number and at least one measurement of effort during the cutting tool usage operation; comparing the collected data, or data which are derived therefrom, with a reference curve or reference discrete values representative of a nominal wear of the cutting tool in the course of the cutting tool usage operations; checking whether or not the collected data, or the data which are derived therefrom, cause an overshoot of a predefined tolerance with respect to the reference curve or respectively to the reference discrete values; and, in the event of the overshoot, deducing an appropriate moment to perform a replacement of the cutting tool, as a function of the overshoot. The tool may then be replaced at or near to that deduced appropriate moment.

### BRIEF DESCRIPTION OF THE DRAWINGS

The abovementioned features of the invention, and others, will become more clearly apparent on reading the following description of at least one exemplary embodiment, the description being given in relation to the attached drawings, in which:

FIG. 1 schematically illustrates an algorithm for estimating the need to replace a cutting tool;

FIG. 2 schematically illustrates a typical curve of wear of a cutting tool over time;

FIG. 3 schematically illustrates a first particular embodiment of estimation of the need to replace the cutting tool;

FIG. 4 schematically illustrates a second particular embodiment of estimation of the need to replace the cutting tool; and

FIG. 5 schematically illustrates an exemplary hardware platform that makes it possible to implement the algorithms presented hereinabove.

### DETAILED DESCRIPTION OF THE PREFERRED EMBODIMENTS

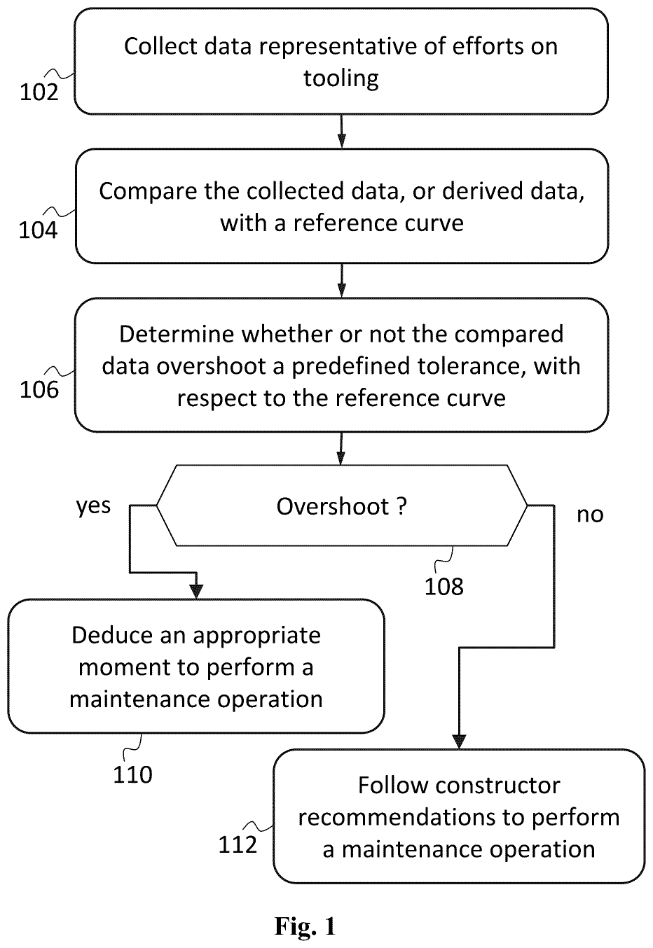

FIG. 1 schematically illustrates an algorithm for estimating the need to replace a cutting tool.

The cutting tool is mounted on a tooling provided with at least one appropriate sensor and configured to perform measurements of efforts undergone by the cutting tool during cutting tool usage operations.

Data representative of these efforts undergone by the cutting tool during cutting tool usage operations are transmitted to a system in the form of electronic circuitry, such as, for example, a computing system, for the data to be analyzed. An arrangement of such a system is presented hereinbelow in relation to FIG. 5.

In a particular embodiment, the tooling is a drilling machine, such as, for example, an electrical drilling unit EDU and the cutting tool is a drill bit. In a particular embodiment, the sensor or sensors are force sensors.

In a particular embodiment, the sensor or sensors are torque meters.

The algorithm of estimating the need to replace the cutting tool proceeds as follows.

In a step 102, the system collects data representative of efforts undergone by the cutting tool in the course of cutting tool usage operations, each datum associating a cutting tool usage operation number and at least one measurement of effort during the cutting tool usage operation. The cutting tool usage operation number therefore provides information on the age (“ageing”) of the cutting tool.

In a step 104, the system compares the collected data, or data which are derived therefrom, with a reference curve representative of a nominal wear of the tooling in the course of the tooling usage operations. It is understood that a use of reference discrete values (in the course of the tooling usage operations) is equivalent to a use of such a reference curve. Thus, the use hereinbelow of the terms “reference curve” can be interchanged with the terms “reference discrete values” without departing from the meaning given in the present invention.

The reference curve can be obtained empirically. The reference curve can be obtained by simulations.

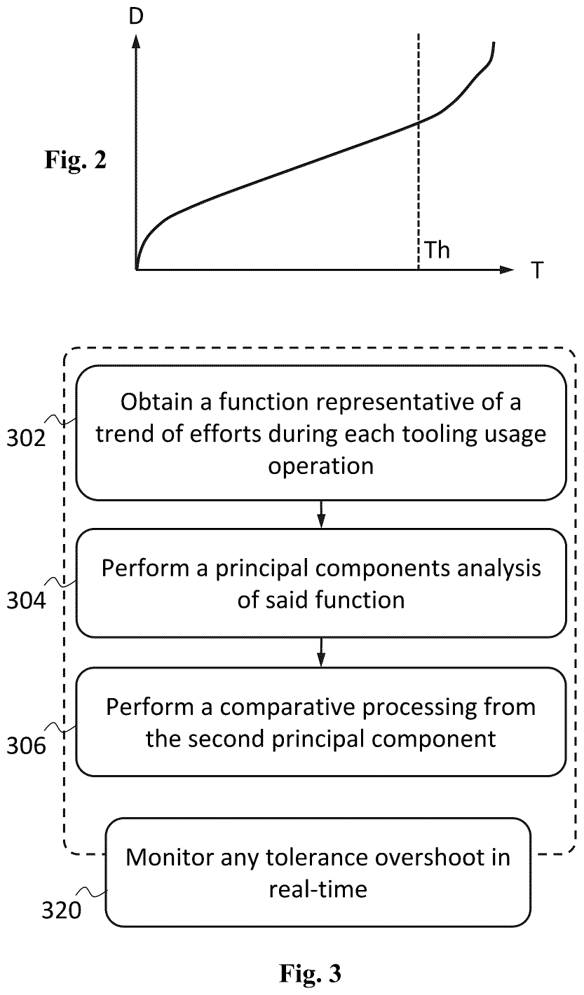

In a particular embodiment, the reference curve has a general appearance as schematically represented in FIG. 2. The x-axis represents the time T, which can be re-transcribed into an equivalent number of tooling usage operations. The y-axis represents a datum D, or a derived datum, representative of an effort undergone during the cutting tool usage operation. Beyond a threshold Th, constructor recommendations recommend proceeding with a replacement of the cutting tool (theoretical wear). The general appearance of the reference curve schematically represented in FIG. 2 is that from “Typical stages of tool wear in machining” by Vaughn, in 1966.

In a step 106, the system determines whether or not the collected data or the data which are derived therefrom (that is to say, the compared data) cause an overshoot of a predefined tolerance with respect to the reference curve. The tolerance can be a plus (actual wear faster than the theoretical wear) or a minus (actual wear slower than the theoretical wear).

Then, in a step 108, the system checks whether or not the compared data cause a predefined tolerance to be overshot with respect to the reference curve. If such is the case, a step 110 is performed; if not, a step 112 is performed. The overshoot of the tolerance can be a single crossing of the tolerance, or a series of crossings of the tolerance.

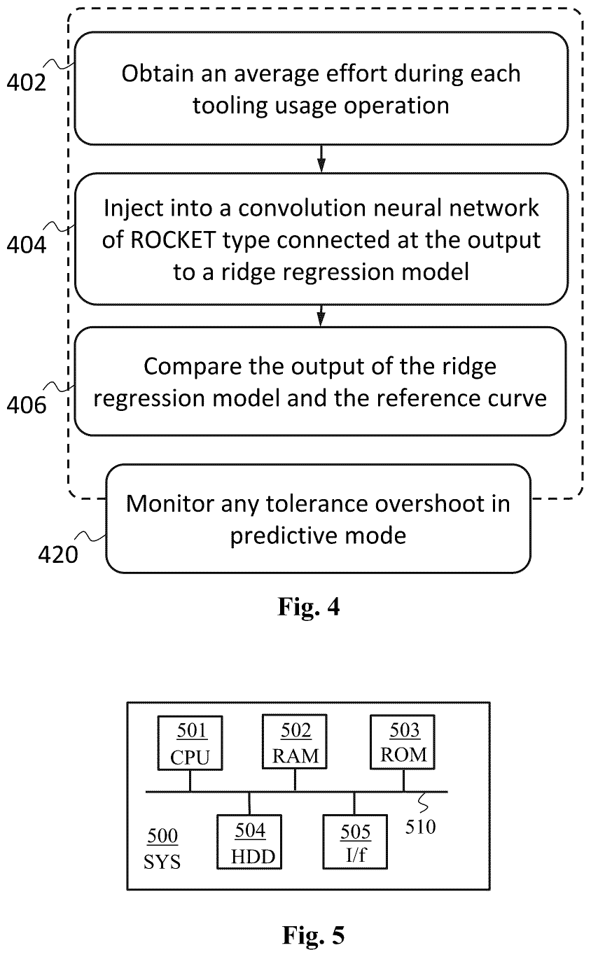

In the step 110, the system deduces an appropriate moment to perform a replacement of the cutting tool, as a function of the overshoot. For example, in real-time, the system issues an alert that it must suspend the operations of use of this cutting tool and replace it. A particular embodiment is detailed hereinbelow in relation to FIG. 3. According to another example, in predictive mode, the system forecasts the future moment at which it is desirable to proceed with the replacement of the cutting tool. A particular embodiment is detailed hereinbelow in relation to FIG. 4. The cutting tool can then be replaced at or near the deduced appropriate moment, or at or near the forecasted future moment.

In the step 112, the system recommends following the constructor recommendations regarding the appropriate moment to perform the replacement of the cutting tool (that is to say, from the threshold Th in FIG. 2).

FIG. 3 schematically illustrates a first particular embodiment of estimation of the need to replace the cutting tool.

This first particular embodiment relies on a Principal Components Analysis PCA. This is a statistical method for reducing the dimensionality of a dataset by linearly transforming the input data into a new system of coordinates in which the most significant part of the variation of the data can be expressed with fewer dimensions. The principal components analysis PCA is therefore a process of computation of the principal components of a dataset and of use of the principal components to perform a change of base. The first principal component of a set of N original variables is a derived variable which is a linear combination of the N original variables, and which shows the greatest variance. The second principal component is a derived variable which is a linear combination of the N original variables and which shows the greatest variance in what remains once the effect of the first principal component has been eliminated. And so on, as necessary.

Here, as detailed hereinbelow, the principal components analysis PCA is applied to a function. The term functional Principal Components Analysis fPCA here applies.

In a step 302, the system obtains a function representative of a trend of efforts during each cutting tool usage operation.

In a particular embodiment, the function concerned is a function of torque measurements in the course of the cutting tool usage operation.

In a step 304, the system performs a principal components analysis of the function in the course of the cutting tool usage operations, that is to say, a functional principal components analysis fPCA.

In a step 306, the system performs a comparative processing from the second principal component.

In the step 306, the system obtains the distribution of values of the second principal component. The system determines the reference curve as being the mean of the distribution, and the system applies a statistical detection of atypical behaviors by considering a standard deviation tolerance with respect to the mean of the distribution. For example, the system uses a Statistical Process Control (SPC) methodology. For example, the tolerance is equal to +/−3 times the standard deviation of the distribution.

In a variant of the step 306, the system compares the second principal component with the reference curve. The reference curve is obtained by extracting the second component in a principal components analysis of the function in cases of nominal wear of the tooling in the course of the tooling usage operations.

The above steps notably allow the system to monitor, in a step 320, any overshoot of tolerance in real-time. The second principal component can thus be analyzed after each cutting tool usage operation and the system can thus generate an alert to stop use of the cutting tool when the overshoot is observed after the cutting tool usage operation.

FIG. 4 schematically illustrates a second particular embodiment of estimation of the need to replace the cutting tool.

This second particular embodiment relies on a use of a convolution neural network of ROCKET (“RandOm Convolutional KErnel Transform”) type connected at the output to a “Ridge Regression Model”. The convolution neural network of ROCKET type is a neural network suitable for extracting “patterns” that are more complex than individual neurons. It is also faster to put in place than a standard neural network because it does not require training. The ridge regression model operates effectively with a lesser quantity of data than the regression models usually used in the deep neural networks.

In a step 402, the system obtains a function representative of a trend of efforts during each cutting tool usage operation.

In a particular embodiment, the function concerned is a function of torque measurements in the course of the cutting tool usage operation.

In a step 404, the system injects the function obtained in the step 402 into the convolution neural network of ROCKET type connected at the output to the ridge regression model.

In a step 406, the system compares the output of the ridge regression model to the reference curve. The reference curve is obtained by injecting data corresponding to a standardization of the function concerned in the convolution neural network of ROCKET type connected at the output to the ridge regression model.

The above steps allow the system to monitor, in a step 420, any overshoot of tolerance in predictive mode. The output of the ridge regression model can thus be analyzed as an average effort undergone by the cutting tool after a certain number of cutting tool usage operations in order to obtain a prediction of average effort in subsequent cutting tool usage operations, and the system can thus notably anticipate a stoppage of use of the cutting tool when there is a divergence greater than the tolerance between the prediction and the reference curve.

FIG. 5 schematically illustrates an example of a hardware platform of a system SYS 500, in the form of electronic circuitry, that makes it possible to implement the steps and algorithms presented hereinabove.

The hardware platform then comprises, linked by a communication bus 510: a processor or CPU (“Central Processing Unit”) 501; a RAM (“Random Access Memory”) memory 502; a read-only memory 503, for example of ROM (“Read Only Memory”) or EEPROM (“Electrically-Erasable Programmable ROM”) type or of Flash type; a storage unit, such as a hard disk HDD (“Hard Disk Drive”) 504, or a storage medium reader, such as an SD (“Secure Digital”) card reader; and an interface manager I/f 505.

The interface manager I/f 505 allows the hardware platform to interact with peripheral devices, such as human/machine interface peripheral devices (input, display of simulation results, et cetera) and/or with a communication network and/or with other equipment, such as sensors.

The processor 501 is capable of executing instructions loaded into the random-access memory 502 from the read-only memory 503, from an external memory, from a storage medium (such as an SD card), or from a communication network. When the hardware platform is powered up, the processor 501 is capable of reading instructions from the random-access memory 502 and of executing them. These instructions form a computer program causing the implementation, by the processor 501, of all or part of the steps and algorithms described here.

All or part of the steps and algorithms described here can thus be implemented in software form by the execution of an instruction set by a programmable machine, for example a processor of DSP (“Digital Signal Processor”) type or a microcontroller, or be implemented in hardware form by a machine or a dedicated electronic component (“chip”) or a dedicated set of electronic components (“chipset”). Generally, the system 500 comprises electronic circuitry adapted and configured to implement the steps and algorithms described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for estimating the need for replacement of a cutting tool, the method being implemented by a system formed of electronic circuitry, the method comprising the following steps:
collecting data representative of efforts undergone by the cutting tool during cutting tool usage operations, each datum associating a cutting tool usage operation number and at least one effort measurement during said cutting tool usage operation;
comparing the collected data, or data which are derived therefrom, with a reference curve or reference discrete values representative of a nominal wear of the cutting tool during the cutting tool usage operations;
checking whether or not the collected data, or the data which are derived therefrom, cause a predefined tolerance to be overshot with respect to the reference curve or, respectively, to the reference discrete values; and
upon detecting a tolerance overshoot, deducing an appropriate moment for a replacement of the cutting tool, as a function of said overshoot.

2. The method according to claim 1, wherein said at least one effort measurement during said cutting tool usage operation includes a torque measurement.

3. The method according to claim 2, wherein said at least one effort measurement during said cutting tool usage operation includes a function of measurements of torque during said cutting tool usage operation.

4. The method according to claim 3, comprising the following steps:
performing a principal components analysis of said function during the cutting tool usage operations;
obtaining a distribution of values of a second principal component, and applying a statistical detection of atypical behaviors by considering a standard deviation tolerance with respect to a mean of the distribution.

5. The method according to claim 3, comprising the following steps:
performing a principal components analysis of said function during the cutting tool usage operations; and
comparing a second principal component to the reference curve or respectively to the reference discrete values.

6. The method according to claim 4, comprising the following step:
monitoring the overshooting, or not, of the predefined tolerance with respect to the reference curve or to the reference discrete values in real-time, during the cutting tool usage operations, and generating an alert to stop use of the cutting tool when said overshoot is observed after a cutting tool usage operation.

7. The method according to claim 3, comprising the following steps:
injecting the collected data into a convolution neural network of ROCKET type connected at the output to a ridge regression model; and
comparing an output of the ridge regression model to the reference curve or respectively to the reference discrete values.

8. The method according to claim 7, comprising the following steps monitoring the overshooting, or not, of the predefined tolerance with respect to the reference curve or to the reference discrete values in predictive mode using the ridge regression model so as to generate an estimation of stoppage of use of the cutting tool.

9. The method according to claim 1, wherein the cutting tool is a drill bit.

10. A system formed of electronic circuitry configured to perform an estimation of need for replacement of a cutting tool and to implement the following steps:
collecting data representative of efforts undergone by the cutting tool during cutting tool usage operations, each datum associating a cutting tool usage operation number and at least one measurement of effort during said cutting tool usage operation;
comparing the collected data, or data which are derived therefrom, with a reference curve or reference discrete values representative of a nominal wear of the cutting tool during the cutting tool usage operations;
checking whether or not the collected data, or the data which are derived therefrom, cause a predefined tolerance to be overshot with respect to the reference curve or respectively to the reference discrete values; and
upon detecting a tolerance overshoot, deducing an appropriate moment to perform a replacement of the cutting tool, as a function of said overshoot.
